(19) United States
(12) Patent Application Publication
(10) Pub. No.: US 2016/0155133 A1
(43) Pub. Date: Jun. 2, 2016

(54) AUTHENTICATION METHOD FOR CONSUMER PRODUCTS VIA SOCIAL NETWORKS

(71) Applicant: NEO ORIGINALITY LTD., Beer Sheva (IL)

(72) Inventors: Danny KNAFOU, Ofakim (IL); Michael HERMAN, Ofakim (IL)

(21) Appl. No.: 14/890,092

(22) PCT Filed: May 8, 2014
(86) PCT No.: PCT/IL2014/050412

§ 371 Date: Nov. 9, 2015

(30) Foreign Application Priority Data
May 9, 2013 (IL) 226282

(51) Int. Cl. G06Q 30/00; G06Q 50/00

(52) U.S. Cl. CPC G06Q 30/0185; G06Q 50/01

(57) ABSTRACT

An authentication system, comprising an active authentication label for consumer products comprising a chip embedded in a substrate that is adhesively attachable to a consumer product. When activated the label generates a normally non-visible code which is usable for authentication purposes. The system also comprises a communication device for receiving and retransmitting the generated code and a server which is in data communication with said communication device, for receiving and authenticating the generated code and for subsequently erasing label related data from a server database to prevent any malicious initiated authentication of the label.

### FIELD OF THE INVENTION

The present invention relates to the field of authentication labels for anti-counterfeiting purposes. More particularly, the invention relates to an active authentication label.

### BACKGROUND OF THE INVENTION

The counterfeiting of high value products is a worldwide problem, and causes large losses to manufacturers, retailers and advertisers due the uncertainty of the product authenticity.

WO 2010/077615 discloses a system and method to authenticate products. Identity data corresponding to products to be sold is stored in a database. The authenticity of the product is determined at a point of sale by comparing the product's identity data, for example a barcode, with the stored identity data. Other prior art authentication systems are disclosed in US 2008/0179390, US 2011/022510, US 2011/0169602 and DE 202004021547.

In all of these prior art systems, a visible code is scanned by an optical reader and compared with a stored code in order to determine product authenticity. However, the visible code itself may be counterfeited by a person who scanned the code applied onto an original product known to be authentic. A counterfeited product will therefore be able to be authenticated due to the matching of the counterfeited code with the stored code.

It is an object of the present invention to provide a label used for authentication purposes that cannot be counterfeited.

Other objects and advantages of the invention will become apparent as the description proceeds.

### SUMMARY OF THE INVENTION

The present invention provides an authentication system, comprising an active authentication label for consumer products comprising a chip embedded in a substrate that is adhesively attachable to a consumer product, for generating, when activated, a normally non-visible code which is usable for authentication purposes; a communication device for receiving and retransmitting said generated code; and a server in data communication with said communication device, for receiving and authenticating said generated code and for subsequently erasing label related data from a server database to prevent any malicious initiated authentication of said label.

The embedded chip preferably comprises a memory device, a processor for generating the authentication code from information stored in said memory device, and an activation device for providing an indication to said processor to initiate a code generation operation after the label has been activated.

In one aspect, one or more product related parameters and an instantiation identifier are stored in the memory device, and the embedded chip of the label further comprises a code generator in which are stored predetermined rules for generating the code as a function of said one or more product related parameters and a transmitter for transmitting the generated code and said instantiation identifier to the communication device.

In one aspect, the authentication code is stored in the memory device and the label further comprises a forwardly facing screen applied onto the substrate on which is displayable the authentication code for a predetermined period of time upon generation of the authentication code.

The present invention is also directed to a method for verifying authenticity of a consumer product, comprising the steps of applying an active authentication label comprising a chip embedded in a substrate to a consumer product, activating said chip, generating a normally non-visible code which is usable for authentication purposes, transmitting said generated code to a server, authenticating said generated code at said server, and erasing label related data from a server database after said code has been authenticated to prevent any malicious initiated authentication of said label.

The present invention is also directed to an active authentication label for consumer products, comprising a substrate that is adhesively attachable to a consumer product, and a chip embedded in said substrate, for generating, when activated, a normally non-visible authentication code, wherein said embedded chip comprises a memory device in which is stored one or more product related parameters and an instantiation identifier, a code generator in which are stored predetermined rules for generating said code as a function of said one or more product related parameters, and a transmitter for transmitting said generated code and said instantiation identifier to a communication device for authentication purposes.

In one embodiment, the steps of transmitting the generated code to a server, authenticating the generated code at the server, and erasing label related data from a server database after the code has been authenticated are performed only after:
a) automatically navigating the buyer of the consumer product to be authenticated to an advertiser's business page, presented via a social network;
b) adding the buyer to the advertiser's social group in response to interaction of the buyer with the business page.

The buyer of the consumer product may remove himself from the advertiser's social group by clicking on an appropriate button in the business page.

The present invention is also directed to a method for verifying authenticity of a consumer product, comprising:
a) applying a passive authentication label which includes a normally invisible unique indicator covered by an opaque scratchable layer that provides protection against reading of the indicator by external devices;
b) scratching the opaque layer and revealing the unique indicator;
c) browsing a business page associated with said product over a social network to activate an authentication process;
d) authenticating said unique indicator at a server; and
e) permanently deleting label related data from a server database after said unique indicator has been authenticated to prevent any subsequent malicious initiated authentication of said label.

The authentication process may be activated by entering the revealed unique identifier into a field of the business page and performing one of the following:
a) typing in the revealed unique indicator into said field;
b) scanning and transmitting the unique indicator into said field; and
c) reading said unique indicator by a reader and transmitting the unique indicator into said field.

In one aspect, the authentication process is activated by transmitting the entered unique indicator to a remote server.

### BRIEF DESCRIPTION OF THE DRAWINGS

In the drawings:

FIG. 1 is a perspective view of an authentication label according to one embodiment of the present invention;

FIG. 2 is a block diagram of a chip embedded within the authentication label of FIG. 1;

FIG. 3 is a method for verifying product authenticity with the label of FIG. 1;

FIG. 4 is a schematic illustration of an actuator for transmitting an actuating signal to an activation device provided with the label of FIG. 1;

FIG. 5 is a schematic illustration of an activation device which is applied to the label of FIG. 1;

FIG. 6 is a schematic illustration of an authentication system using a label according to another embodiment of the invention;

FIG. 7 is a block diagram of a chip embedded within the authentication label of FIG. 6;

FIG. 8 is a method for verifying product authenticity with the label of FIG. 6;

FIG. 9 is a method for verifying product authenticity according to another embodiment of the invention;

FIGS. 10 and 11 are two exemplary product-specific authenticity reports, respectively, which can be generated by the system of the present invention; and

FIG. 12 is a method for verifying product authenticity according to another embodiment of the invention.

### DETAILED DESCRIPTION OF PREFERRED EMBODIMENTS

The novel authentication label of the present invention is an active label and generates a code that is normally not visible to passes by. In contrast to prior art authentication labels bearing a visible code that is scanned by an optical reader and that is liable to be counterfeited by a malicious person, the authentication code generated by the label of the present invention cannot be duplicated and is assured of enabling a reliable authentication operation.

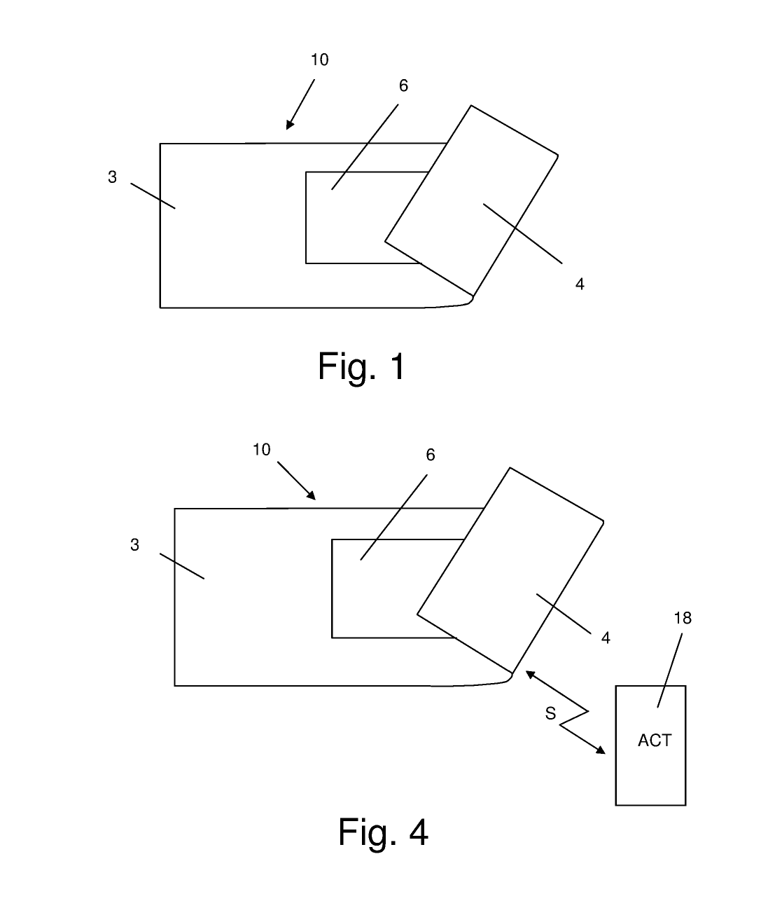

FIG. 1 illustrates a perspective view of an authentication label according to one embodiment of the present invention, and is generally indicated by numeral 10. Authentication label 10 comprises a main substrate 3 having a rearwardly facing adhesive layer 4 facilitating adhesion to a product desired to be authenticated and a forwardly facing screen 6 applied onto substrate 3. The code that is generated by a processor embedded in substrate 3 during the authentication process is temporarily displayed on screen 6. In order to be properly applied onto a curved surface or other non-planar surface of the product, label 10, including substrate 3, screen 6 and the embedded chip, is flexible.

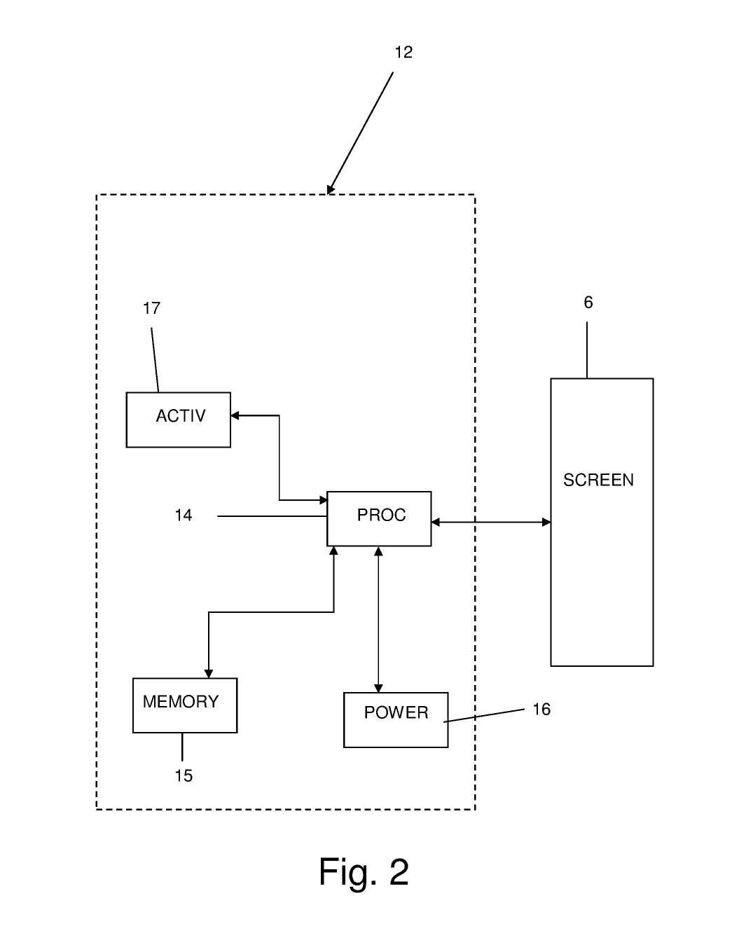

FIG. 2 illustrates a block diagram of chip 12 embedded within the authentication label. Embedded chip 12 comprises a memory device 15 in which is stored the authentication code, a power source 16, and an activation device 17 as will be described hereinafter, all of which are in communication with processor 14. Processor 14, which is in communication with screen 6, is programmed to cause the stored authentication code to be displayed only after the active label is first activated.

The authentication code is factory generated and a single copy of which is stored in the database of an authentication server, which is in data communication with a plurality of distributed point of sale (POS) devices adapted to perform authentication operations.

An authentication code is generally indicative of several product related parameters, including a manufacturer identifier, a product identifier, and a batch number associated with a manufacturing time. Each instantiation of the product is also assigned a unique indicator, which is generated serially, randomly or according to predetermined rules. The unique indicator may also include an activation device identifier. A list of the generated unique indicators or of the composite authentication codes may be reviewed to verify that none have been assigned more than once.

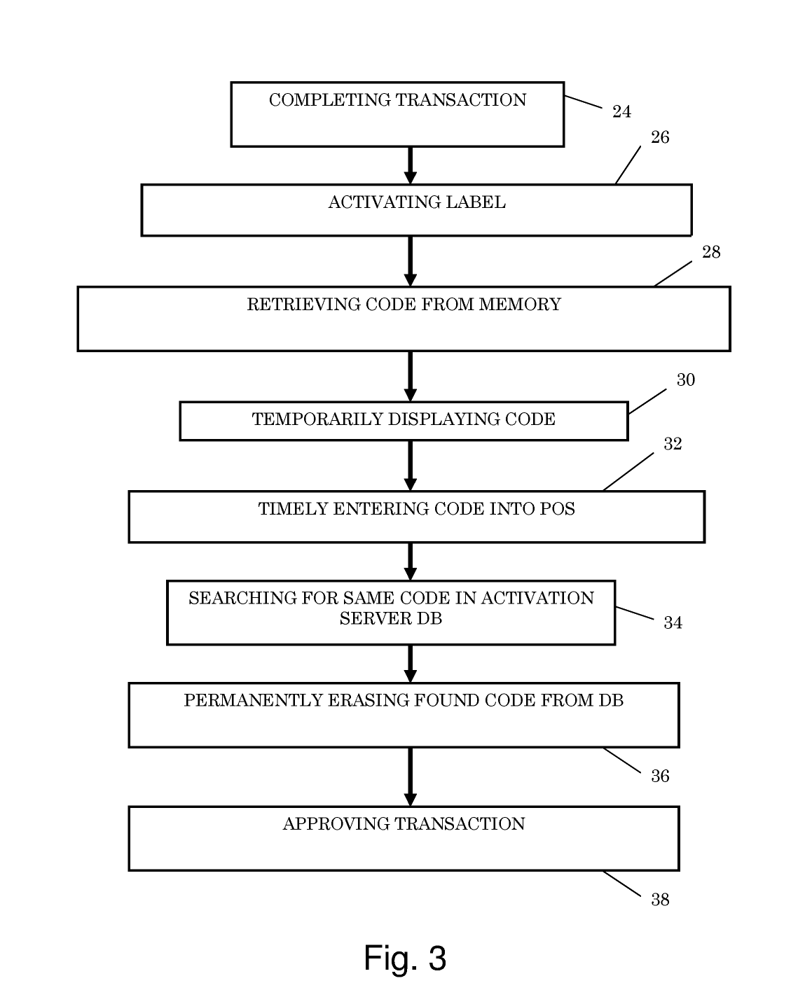

FIG. 3 illustrates a method for verifying product authenticity with the label of FIG. 1.

After a consumer completed a transaction in step 24, such as by means of a credit card, in order to purchase a specific product, active label 10 is first activated in step 26 by the consumer or by the cashier (hereinafter the “initiator”) at the POS.

The activation device may be a sensor such as a heat sensor, an electric field sensor, and a magnetic field sensor, which is activated upon operating hand manipulated actuator 18, e.g. a remote control device, shown in FIG. 4. Actuator 18, after being operated, transmits an actuating signal S to the activation device. If the activation device is configured to detect actuating signal S, e.g. the activation device is a heat sensor when the actuating signal is a thermal signal, and is located within a detectable range thereof, the activation device transmits an activating signal to the processor. Transmission of the activating signal indicates that the initiator of the authentication operation (1) is aware that the authentication label needs to be activated and (2) is aware of the type of activation device employed in the given authentication label.

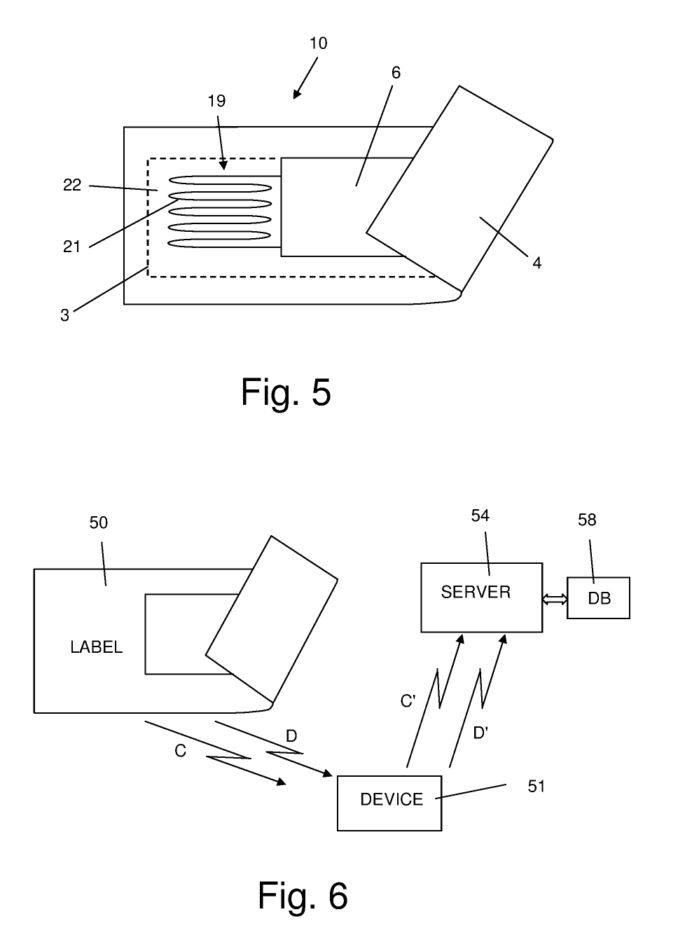

Alternatively, the activation device is a conductor sense loop 19 shown in FIG. 5. Sense loop 19, which comprises a plurality of breakable conductors 21 in communication with the processor, is applied to substrate 3 surrounding screen 6 of flexible active label 10 and is concealed by the schematically illustrated scratch pad layer 22. In order to activate the label, the initiator scratches layer 22, causing a change in an electrical property of the current flowing in sense loop 19, e.g. resulting in open circuit conditions, to be sensed by the processor.

Referring back to FIG. 3, the processor, after being indicated that the label has been activated, retrieves the authentication code from the memory device in step 28 and temporarily causes the same to be temporarily displayed in step 30. The initiator enters the displayed authentication code into the POS in step 32 within a predetermined period of time and transmits the same to the authentication server. Alternatively, a mobile communication device captures an image of the generated authentication code and wirelessly transmits the same to the authentication server. The authentication server searches the database in step 34 for the same authentication code. If found, the authentication server permanently erases the same authentication code from the database in step 36, thereby preventing any malicious person from initiating authentication of the same code. The transaction is then approved in step 38. However, if the authentication server was not able to find the same authentication code in the database or the authentication code was not entered within the predetermined period of time, the transaction is denied and the product, as well as the previously presented payment means, is returned.

It will be appreciated that a consumer may also activate label 10 prior to completing the transaction and then wirelessly transmit the generated code by a mobile communication device to the authentication server.

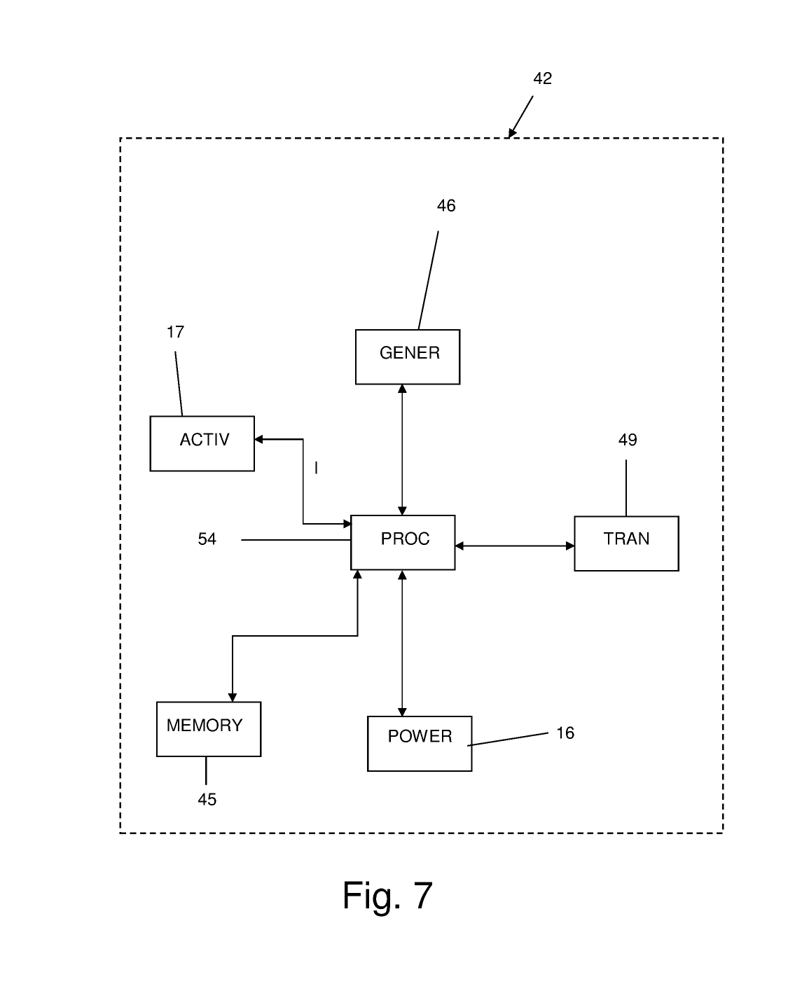

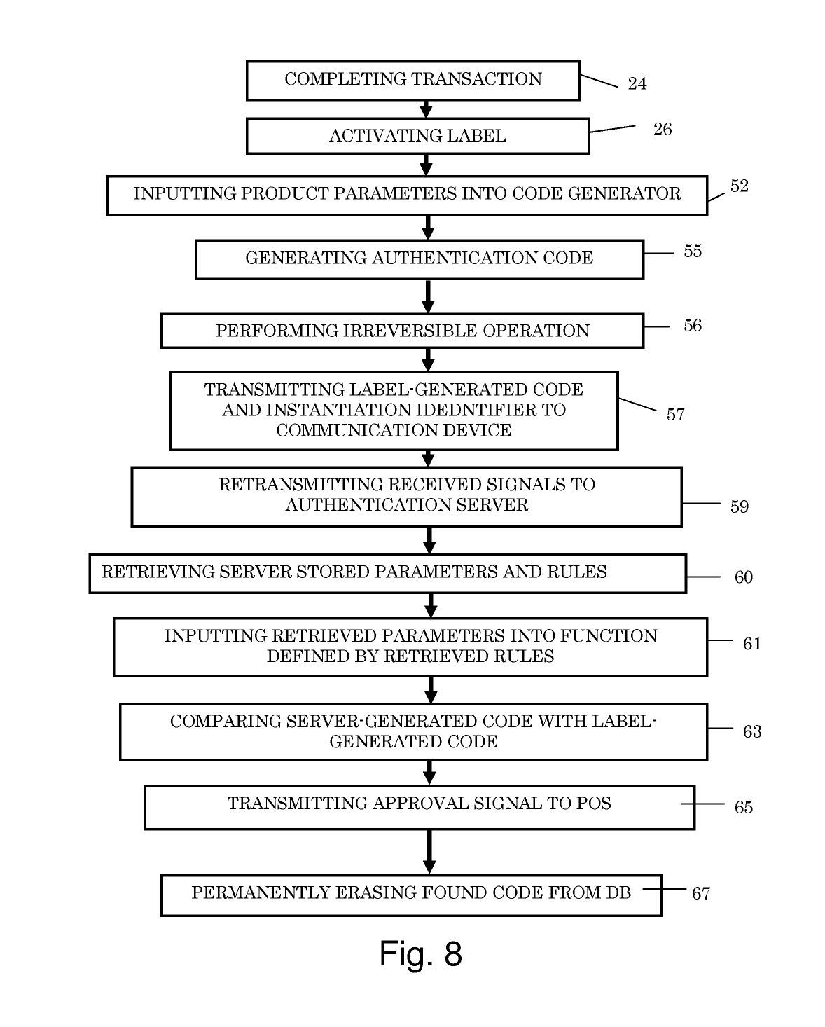

FIGS. 6-8 illustrate another embodiment of the invention, which provides additional precautions to prevent reusing the authentication code. In this embodiment, label 50 is configured without a screen, and embedded chip 42 comprises power source 16, an activation device 17, a memory device 45 in which is stored one or more product related parameters which may include an instantiation identifier, a code generator 46 is which are stored predetermined rules generally defining a function, e.g. a hash function, for generating the authentication code from the stored one or more product related parameters, and a transmitter 49 for wirelessly transmitting the generated code to an external processor commanded device 51, e.g. a POS or a mobile communication device such as a smartphone.

Following a first predetermined time following receiving indication I from activation device 17 that label 50 has been activated, processor 54 in communication with the components of embedded chip 42 inputs the stored product related parameters at step 52 into code generator 46 to generate the authentication code in step 55 and commands in step 57, following a second predetermined time, transmission of wireless signal C representative of the generated authentication code and signal D representative of the instantiation identifier.

Device 51 is provided with a dedicated application for automatically receiving the transmitted signals C and D, and for retransmitting the received signals in step 59 to authentication server 54 by signals C′ and D′, respectively.

In a database 58 of authentication server 54 is stored, e.g. locally and securely, categorized information for each of a plurality of manufactured active labels. The categorized information includes the same product related parameters as stored in memory device 45, as well as the same predetermined rules as stored in code generator 46. Thus after authentication server 54 receives signals C′ and D′, it retrieves in step 60 the stored product related parameters and predetermined rules associated with the instantiation identifier provided in signal D′, and then inputs the retrieved product related parameters into the function defining the retrieved predetermined rules to generate the authentication code in step 61. The server-generated code is compared in step 63 with the label-generated code provided in signal C′. If the server-generated code matches the label-generated code, server 54 authenticates the label and transmits an approval signal to the POS in step 65. Following transmission of the approval signal, the authentication server may permanently erase the product related parameters and/or the predetermined rules from database 58 in step 67, in order to prevent the authentication code from being generated a second time by malicious people.

Processor 54 may be programmed to perform an irreversible operation in step 56 at a predetermined time following generation of the label-generated code, to prevent reuse of the authentication code by malicious people. The irreversible operation may be permanent erasing of memory device 45, disabling the link between memory device 45 and processor 54, disabling activation device 17, or any other action that will prevent generation of the authentication code at a later time. In order to prevent unnecessary damage to the label as a result of the irreversible operation, authentication of the label is performed at the POS only after the transaction has been completed in step 24.

As may be appreciated from the above description, the use of the active label reassures consumers that a high value product desired to be purchased is a genuine and non-counterfeited.

The authentication process using the label of the present invention allows any user who purchased a plurality of different products to verify whether or not these items are original products, through a single platform which aggregates online authentication data for all products.

In one embodiment, the authentication process urges consumers to use platforms such as social networks, known primarily to support interaction by non-commercial users, for authentication purposes through a social network business page. Actually, interaction activities in the business pages are of great importance both to the social networks' business model, as well as to the business page owners, i.e. the advertisers, who invest much effort and resources in developing and updating the business page. Advertisers have a great interest in increasing the number of users that visit and use their business page, as well as in the number of friends in the advertiser's social group (in the example of Facebook, the number of users that become “friends” in the advertiser's social group by clicking on the Like button).

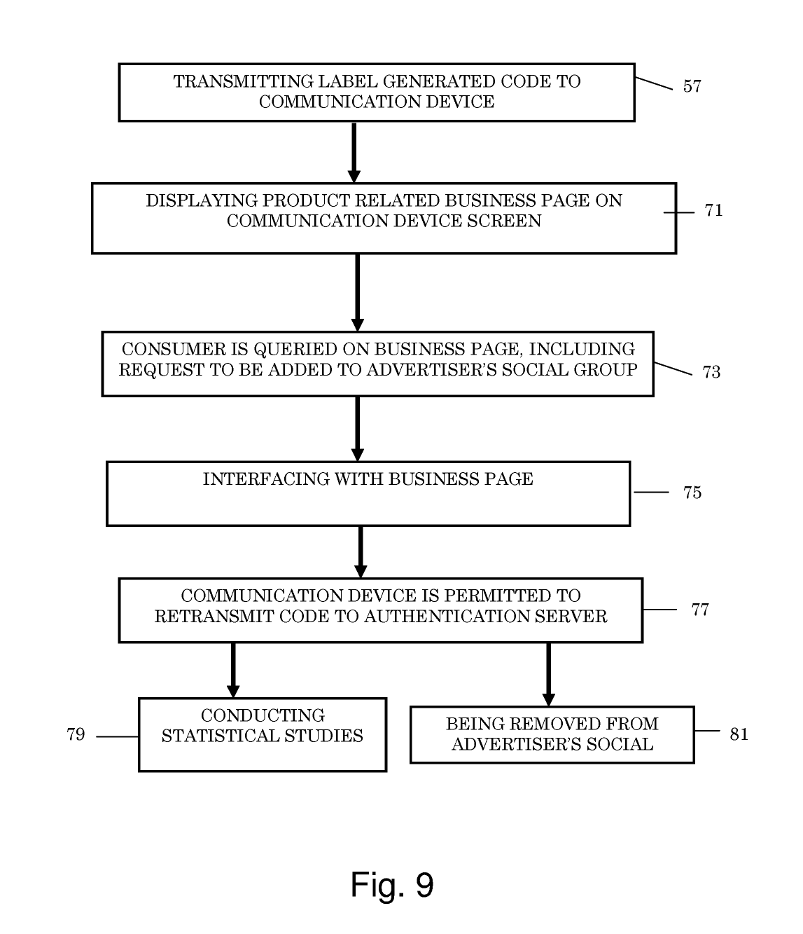

As shown in FIG. 9, a business page associated with the product identifier is displayed in step 71 on the screen of the communication device, whether a point of sale device or a mobile device, after the generated code has been transmitted thereto in step 57. In the same URL that provides access to the advertiser's business page, the consumer is asked in step 73, so that the authentication process will be permitted to proceed, to interact with the business page (e.g., by clicking on the Like button) and add himself to the advertiser's social group. By doing so, the consumer becomes a member of the social network, as well. Such interaction by a large number of consumers will dramatically increase the number of friends in the advertiser's social group and will correspondingly increase the advertising influence of the given product and generate higher revenue. The consumer may be queried by a pop-up window, or by any other suitable means well known to those skilled in the art. In addition to being asked to be added to the advertiser's social group, the consumer may be queried as to the location of the purchase, the price of the purchase, or any other purchase related data. After the consumer interacts with the business page in step 75, the communication device is permitted to retransmit the generated code to the authentication server in step 77.

Interaction with the business page allows the advertiser to conduct statistical studies in step 79 concerning those geographical areas in which there is a greater propensity for counterfeiting. That is, aggregated purchase history over time may be obtained, including the store name and location at which each purchase was made, the price of the purchased product, warranty information, and whether the product was found to be counterfeited.

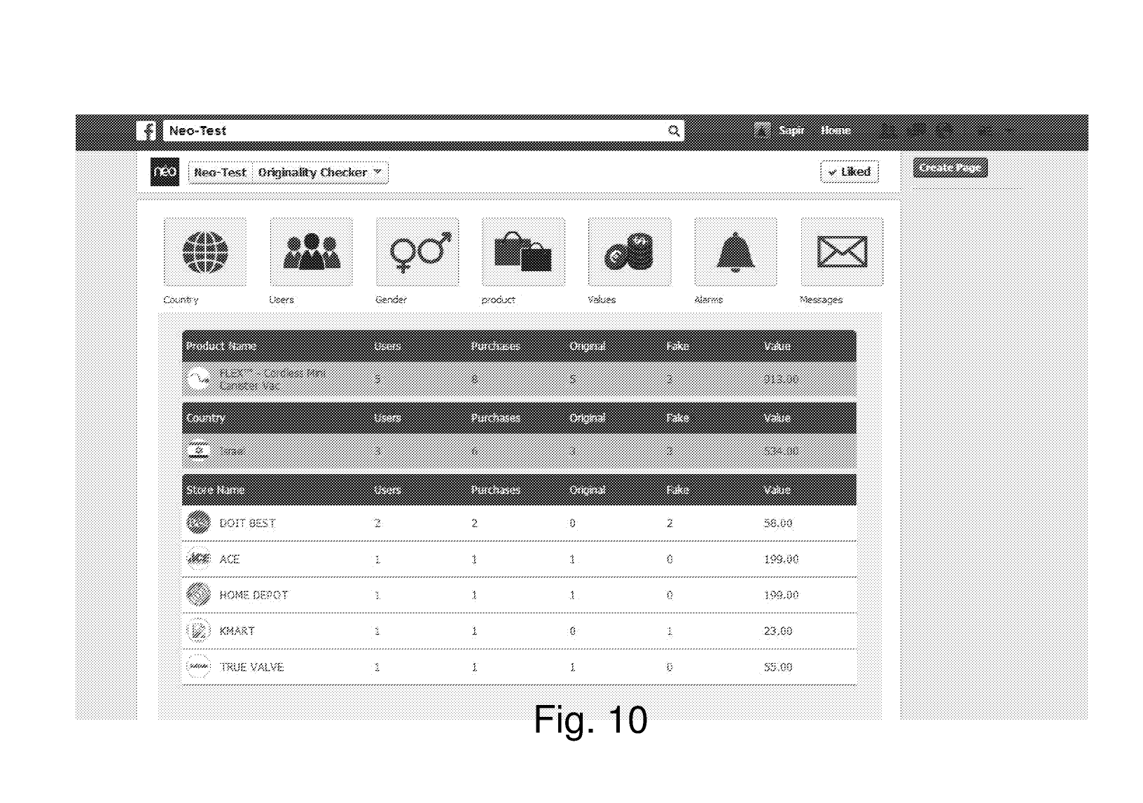

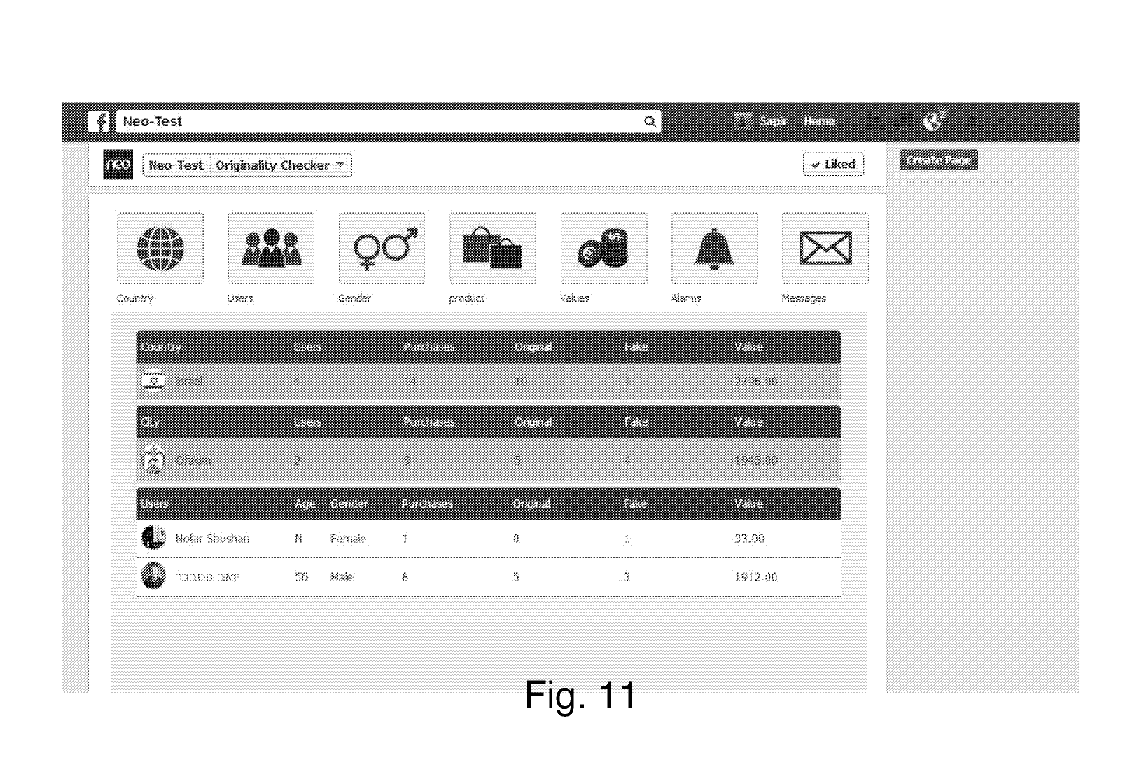

FIGS. 10 and 11 illustrate exemplary product-specific authenticity reports generated by a business page statistical module. Additional information may be provided upon clicking one of the displayed buttons. Since the during the authentication process the user automatically becomes a member (a friend) in the advertiser's social group, the advertiser can collect information about each user who purchased a product from the user's profile. This allows collecting important information about users who purchased each product of the advertiser (which can be the product's manufacturer), in order to continue being in contact with him in the future. Also by collecting information about the authentication results, it is possible to detect which products are subject to counterfeiting, in which percentage and in which places (e.g., countries, cities, stores). It is also possible to collect information about the price which was paid by each user for the same product.

In the example of FIG. 10, the product is a FLEX™-Cordless Mini Canister Vacuum cleaner. It can be seen that 6 units were sold in Israel, 3 of which were found to be fake. It also can be seen that 2 fake units were sold in Do it Best hardware store and one in Kmart department store. Therefore, the distribution of sales may be obtained and analyzed, according to country, users, product types, pricing, gender, etc.

In the example of FIG. 11, the distribution of sales may be obtained and analyzed, according to country, city, users' profiles (age, gender, and profession), etc.

According to another embodiment, each user who completed the authentication process can store the purchasing information online, for getting future data about warranty, pricing, best stores. He also can share information with other users who purchased similar products, compare prices and get insights about sales and recommended stores.

If for some reason, the consumer does not wish to belong to the advertiser's social group (i.e., being a friend), he can subsequently remove himself from the advertiser's social group by clicking in step 81 on an appropriate button (e.g., an “Unlike” button) in the business page.

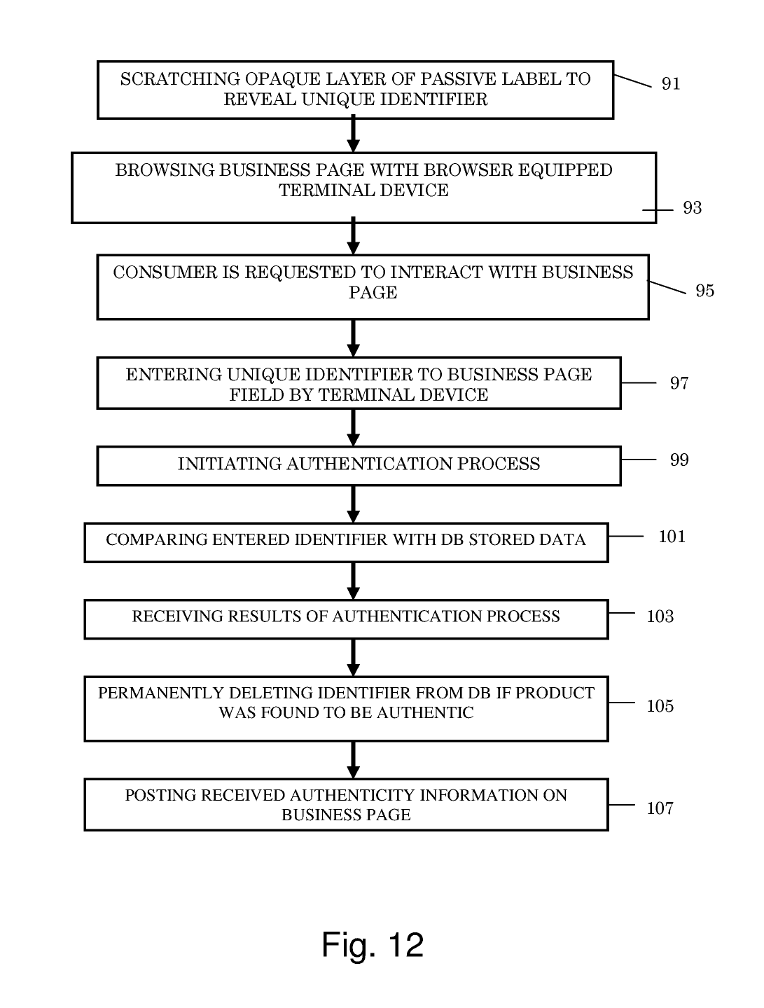

According to another embodiment illustrated in FIG. 12, the authentication label can be a passive label that is provided with the unique indicator. The unique identifier is imprinted on a substrate, or otherwise displayed, and covered by an opaque scratchable layer, made for example from lead (which provides protection against a fraudulent reading of the code by external devices).

In this embodiment, the consumer who purchased the product can initiate the inventive authentication process from any remote place and at any time. For example, the buyer can go home, scratch the opaque layer to reveal the unique indicator in step 91 and then initiate the authentication process after browsing in step 93 the business page of the advertiser (who is usually the manufacturer of the product) via a terminal device (such as his computer, his smartphone, a smart TV, or any type of electronic device with an appropriate browser, such as Google Glass which is a wearable computer with an optical head-mounted display, a wearable computing system disclosed in U.S. Pat. No. 8,223,024 or a head-mounted display disclosed in US 2012/0293548, or a Wireless Head-Mounted Display with embedded Linux (WXHMD) disclosed in http://www.pabr.org/wxhmd/doc/wxhmd.en.html).

The consumer is requested in step 95 to interact with the business page and to be added to the advertiser's social group, if not already a member thereof. In order to verify authenticity of the purchased product, the consumer enters the unique indicator into an appropriate field of the business page by the terminal device in step 97. The unique identifier is entered by performing one of the following operations:
Typing in the revealed unique indicator;
Scanning the unique indicator (e.g., by an optical reader); and
Reading the unique indicator by another type of reader, such as a magnetic reader (in case when the unique indicator is encapsulated in a magnetic media) or an RF detector (in case when the unique indicator is encapsulated in an RF media, such as an RF tag).

After the unique indicator has been entered, the authentication process is initiated in step 99. If the business page resides at the authentication server, the authentication server compares the entered identifier with data stored in a local database in step 101, otherwise the entered identifier is automatically redirected to the remote authentication server. The consumer then receives an indication in step 103 as to the results of the authentication process, i.e. whether the purchased product was found to be authentic. If the purchased product was found to be authentic, the unique identifier is permanently deleted from the database in step 105, to prevent reuse of the identifier. The consumer is able to post the received authenticity information on the business page in step 107 by the terminal device, so as to share the information with other consumers via the social network.

According to another embodiment, the authentication process of the present invention may be implemented also for verifying the authenticity of data usually printed on the package of products such as food. This data may include ingredients, expiration date, fitness in accordance with religious law, etc. In this example, the authentication label (e.g., in the form of a QR code) will be scanned by the buyer and the buyer will again be directed to the URLs that provide access to the advertiser's (the manufacturer) business page by asking the user to interact with the business page (e.g., by clicking on the Like button) and add himself to the advertiser's social group. Then the authentication process will be carried out, ending with authentic results that will be displayed to the user, who will be able to compare them with the data printed on the package. For example, if the data printed on the package specifies the percentage of fat in a particular food, the same percentage should appear in the data displayed on the advertiser's (the manufacturer) business page, which is the most reliable data.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims

1-36. (canceled)

37. An authentication system, comprising:
(a) an active authentication label for consumer products comprising a chip embedded in a substrate that is adhesively attachable to a consumer product, for generating, when activated, a normally non-visible code which is usable for authentication purposes;
(b) a communication device for receiving and retransmitting said generated code; and
(c) a server in data communication with said communication device, for receiving and authenticating said generated code and for subsequently erasing label related data from a server database to prevent any malicious initiated authentication of said label.

38. The authentication system according to claim 37, wherein the embedded chip comprises a memory device, a processor for generating the authentication code from information stored in said memory device, and an activation device for providing an indication to said processor to initiate a code generation operation after the label has been activated.

39. The authentication system according to claim 38, wherein one or more product related parameters and an instantiation identifier are stored in the memory device, and the embedded chip of the label further comprises a code generator in which are stored predetermined rules for generating the code as a function of said one or more product related parameters and a transmitter for transmitting the generated code and said instantiation identifier to the communication device.

40. The authentication system according to claim 38, wherein the authentication code is stored in the memory device and the label further comprises a forwardly facing screen applied onto the substrate on which is displayable the authentication code for a predetermined period of time upon generation of the authentication code.

41. The authentication system according to claim 40, wherein the communication device is a mobile device which is operable for capturing the displayed authentication code and for transmitting the same to the server.

42. The authentication system according to claim 40, wherein the authentication code is also stored in the server database, the server, after having authenticating the code, being operable to erase the code from the server database.

43. The authentication system according to claim 39, wherein the communication device is operable to transmit the generated code and the instantiation identifier to the server.

44. The authentication system according to claim 39, wherein the processor is operable to perform an irreversible operation at a predetermined time following generation of the code to prevent reuse of the code.

45. Method for verifying authenticity of a consumer product, comprising the steps of:
(a) applying an active authentication label comprising a chip embedded in a substrate to a consumer product;
(b) activating said chip;
(c) generating a normally non-visible code which is usable for authentication purposes;
(d) transmitting said generated code to a server;
(e) authenticating said generated code at said server; and
(f) erasing label related data from a server database after said code has been authenticated to prevent any malicious initiated authentication of said label.

46. The method according to claim 45, wherein the code is generated at the label by inputting one or more stored product parameters into a code generator.

47. The method according to claim 45, wherein the generated code is displayed on a screen provided with the substrate and the displayed code is then entered into a communication device, whereupon said entered code is transmitted to the server.

48. The method according to claim 47, wherein the server authenticates the code by receiving the code from the communication device and then searching for the code in the database.

49. An active authentication label for consumer products, comprising:
(a) a substrate that is adhesively attachable to a consumer product; and
(b) a chip embedded in said substrate, for generating, when activated, a normally non-visible authentication code, wherein said embedded chip comprises:
(i) a memory device in which is stored one or more product related parameters and an instantiation identifier;
(ii) a code generator in which are stored predetermined rules for generating said code as a function of said one or more product related parameters; and
(iii) a transmitter for transmitting said generated code and said instantiation identifier to a communication device for authentication purposes.

50. The method according to claim 45, wherein the steps of transmitting the generated code to a server, authenticating the generated code at the server, and erasing label related data from a server database after said code has been authenticated are performed only after:
(a) automatically navigating the buyer of the consumer product to be authenticated to an advertiser's business page, presented via a social network; and
(b) adding said buyer to the advertiser's social group in response to interaction of said buyer with said business page.

51. The method according to claim 50, further comprising allowing the buyer of the consumer product to remove himself from the advertiser's social group by clicking on an appropriate button in the business page.

52. Method for verifying authenticity of a consumer product, comprising:
(a) applying a passive authentication label which includes a normally invisible unique indicator covered by an opaque scratchable layer that provides protection against reading of said indicator by external devices;
(b) scratching said opaque layer and revealing said unique indicator;
(c) browsing a business page associated with said product over a social network to activate an authentication process;
(d) authenticating said unique indicator at a server; and
(e) permanently deleting label related data from a server database after said unique indicator has been authenticated to prevent any subsequent malicious initiated authentication of said label.

53. The method according to claim 52, wherein the authentication process is activated by entering the revealed unique identifier into a field of the business page and performing one of the following:
(a) typing in the revealed unique indicator into said field;
(b) scanning and transmitting the unique indicator into said field; and
(c) reading said unique indicator by a reader and transmitting the unique indicator into said field.

54. The method according to claim 53, wherein the authentication process is activated by transmitting the entered unique indicator to a remote server.

55. The method according to claim 52, further comprising:
(a) collecting information about each user who purchased a product from the user's profile; and
(b) communicating with said user, based on the collected information and the products purchased by said user.

56. The method according to claim 52, further comprising:
(a) collecting information about each user who purchased a product from the user's profile;
(b) based on the authentication results and on the collected information related to products purchased by all users, performing statistical analysis regarding:
the amount of product counterfeiting;
counterfeiting geographic distribution;
counterfeiting distribution between stores;
pricing.

57. The method according to claim 56, further comprising allowing each user to store data regarding his purchasing history and/or share information with other users of the social network who purchased similar products.
